(19) United States
(12) Patent Application Publication
(10) Pub. No.: US 2004/0078626 A1
(43) Pub. Date: Apr. 22, 2004

(54) System and method for failure recovery of high-speed modems

(76) Inventor: Chuang Li, Saratoga, CA (US)

Correspondence Address: FISH & NEAVE, 1251 AVENUE OF THE AMERICAS, 50TH FLOOR, NEW YORK, NY, 10020-1105, US

(21) Appl. No.: 10/361,713

(22) Filed: Feb. 6, 2003

Related U.S. Application Data
(63) Continuation-in-part of application No. 10/234,544, filed on Aug. 30, 2002.

(51) Int. Cl. G06F 11/00; G06F 15/16

(52) U.S. Cl. 714/4; 709/227

(57) ABSTRACT

A system and method for providing uninterrupted Internet access to users in a local area network is described. The system and method provide failure recovery of a high-speed modem through dial-up modem access without requiring additional hardware in the router. The system and method enable the router to automatically switch from a high-speed modem to a dial-up modem so that the switch is transparent to all the users in the local area network.

### REFERENCE TO RELATED APPLICATIONS

This application is a continuation-in-part of U.S. patent application Ser. No. 10/234,544, filed Aug. 30, 2002, the entirety of which is incorporated herein by reference.

### FIELD OF THE INVENTION

This invention relates generally to a system and method for providing uninterrupted Internet access using high-speed modems. More specifically, the present invention provides a system and method for failure recovery of high-speed modems.

### BACKGROUND OF THE INVENTION

The popularity of the Internet has grown rapidly over the past several years. A decade ago, the Internet was limited to the academic and research community. Today, the Internet has grown into a communications network that reaches millions of people around the world. It provides a powerful and versatile environment for business, education, and entertainment. Millions of people worldwide access the Internet daily for communicating, retrieving information, shopping, and exploiting various other services. The increasing use of the Internet combined with the large number of services provided have created a virtually insatiable demand for faster, cheaper, and reliable, around-the-clock Internet access.

Traditional Internet access has involved two options. First, Internet access is provided with the use of a computer with a direct connection to the Internet backbone. In this case, bandwidths of up to 100 Mbps are achieved, but at the cost of a very expensive infrastructure usually deployed only at large academic, governmental, and business institutions. Second, a very low cost solution to Internet access is provided with the use of a computer equipped with a dial-up modem that connects to the Internet backbone through existing telephone lines. While this solution has vastly popularized Internet use among home users, its low bandwidth of only up to 56 Kbps for V.90 dial-up modems makes it impractical and frustrating for users to access a variety of Internet services requiring high transmission rates, especially multimedia intensive applications involving video and audio streaming.

To address the need for fast and reliable Internet access at an affordable price, a new set of technologies has recently been developed. Users can now choose between high-speed Internet connections provided by T1 or T3 lines leased from telephone companies, cable modems, or DSL modems.

The first option can carry data at a rate of up to 1.5 Mbps, roughly 60 times more than a normal residential modem, and requires a point-to-point dedicated physical connection between the user's computer and the telephone company's switch. This option provides uninterrupted Internet access as a result of using the reliable TCP/IP protocol to carry data through the Internet backbone, which consists of innumerous routers that can be used in case any one of the routers or other network equipment fails. However, T1 lines are still prohibitively expensive and not widely available to the average Internet user.

Alternatively, the second and third options provide relatively inexpensive and high bandwidth Internet access. Users may access the Internet by connecting a high-speed cable modem to an existing cable line or by connecting a high-speed DSL modem to an existing phone line. The cable modem may be integrated with a TV set-top box or it may be a standalone device that is internal or external to a computer. A typical cable modem connection achieves bandwidths of anywhere from 3 to 50 Mbps, while a typical DSL connection achieves rates of 640 Kbps downstream (from the Internet to the user's computer) and 128 Kbps upstream (from the user's computer to the Internet), with the actual bandwidth depending on the distance from the user's computer to the telephone company's central office (the longer the distance, the slower the connection).

Besides a cable or DSL modem, all the other infrastructure required for high speed Internet access is provided by the cable or telephone company and is therefore transparent to the user. The only costs incurred by the user to have a much higher bandwidth connection to the Internet as compared to using a standard dial-up modem connection are the installation costs of the high speed modem and the service fees charged by the cable or DSL service provider.

In addition, a single Internet connection can be shared by multiple machines in a local area network (“LAN”) by using a router coupled with the high speed modem. The router is a device placed between each one of the computers in the LAN and the Internet for forwarding packets to their destination. The router may be integrated with the modem in a single device or connected externally to the modem and each one of the computers in the LAN. This configuration is especially attractive to home users or small business owners that have multiple machines and a high demand for fast Internet access.

However, the use of high-speed cable or DSL modems does not guarantee a reliable Internet connection. When the cable or DSL modem fails and the Internet connection is interrupted, the user is forced to wait for the modem to recover on its own or request technical support from the cable or DSL service provider to repair the modem before re-establishing the high-speed Internet access. Alternatively, the user may manually connect to the Internet using the dial-up modem that is typically embedded in his/her computer. And in case the user is connected to a cable or DSL modem through a router in a LAN configuration, only one computer in the LAN will be able to switch to dial-up modem service through a single phone line.

To address the need for fast, around-the-clock Internet access, backup technologies for high-speed modems have been developed. The backup technologies provide an alternative Internet connection via a dial-up modem for all users in a LAN in case the high-speed modem connection fails. In a typical scenario, the router handles switching to an integrated V.90 or ISDN backup connection in the event of high-speed modem failure.

These backup technologies require the router to be equipped with additional software as well as a data pump and additional DAA circuitry to implement the backup connection. The router also requires an internal V.90 modem, a V.90 module slot, or a serial port for connectivity with a standalone V.90 modem. Examples include the R6131 router sold by Netopia, Inc., of Alameda, Calif., and the FriendlyNET™ FR3004C router sold by Asante Technologies, Inc., of San Jose, Calif.

Although enabling all users in a LAN to have uninterrupted Internet access, these backup technologies are complex to configure, expensive, and require significant software and hardware changes to the router infrastructure. In addition, the extra hardware in the router may add more points of potential network failure and result in additional costs. Furthermore, the backup technologies are designed for users in a LAN only and do not enable a user connected directly to a modem, i.e., without the need of a router, to automatically connect to a dial-up modem when the high-speed modem fails.

In view of the foregoing drawbacks, it would be desirable to provide a system and method for failure recovery of a high-speed modem that do not require additional hardware.

It further would be desirable to provide a system and method for automatic failure recovery of a high-speed modem connected directly to a user.

It also would be desirable to provide a system and method for failure recovery of a high-speed modem connected to a user through a router that do not require significant software and hardware changes in the router.

### SUMMARY OF THE INVENTION

In view of the foregoing, it is an object of the present invention to provide a system and method for failure recovery of a high-speed modem that do not require additional hardware.

It is a further object of the present invention to provide a system and method for automatic failure recovery of a high-speed modem connected directly to a user.

It is also an object of the present invention to provide a system and method for failure recovery of a high-speed modem connected to a user through a router that do not require significant software and hardware changes in the router.

These and other objects of the present invention are accomplished by providing a system and method for failure recovery of a high-speed modem that is directly connected to an Internet appliance or that is connected to various Internet appliances through a router. Internet appliances are electronic devices configured with an Internet access system such as personal and portable computers, electronic organizers, personal digital assistants (“PDAs”), wireless telephones, entertainment systems, stereo systems, video game units, household appliances, or embedded electronic devices, among others.

In a first embodiment of the present invention, when the high-speed modem is connected to a single Internet appliance directly, without the need of a router, the failure recovery is accomplished by monitoring the status of the high-speed modem and launching a dial-up connection on the Internet appliance automatically, i.e., without user intervention, when the high-speed modem fails. In this embodiment, the system of the present invention involves three components: (1) a modem monitoring software module resident on the high-speed modem; (2) a modem access software module resident on the Internet appliance; and (3) a communications protocol.

The modem monitoring software module resident on the high-speed modem monitors the operation of the high-speed modem to detect any high-speed modem failure. If the high-speed modem fails, the modem monitoring software module communicates the failure to the modem access software module resident on the Internet appliance using the communications protocol. The modem access software module automatically launches a dial-up connection on the Internet appliance without interruption of Internet access. The dial-up connection is launched on a dial-up modem that may be a standalone device connected to the Internet appliance or integrated into the Internet appliance.

In a second embodiment of the present invention, the high-speed modem is connected to an Internet appliance directly, without the need of a router, and the Internet appliance shares the high-speed modem to other Internet appliances by means of an Internet Connection Sharing (“ICS”) module in the Internet appliance. The Internet appliance may be connected to other Internet appliances by several means, including using a wireless access point to communicate with the other Internet appliances wirelessly. In this second embodiment, failure recovery is accomplished similarly to the first embodiment, by monitoring the status of the high-speed modem and launching a dial-up connection and an ICS module on the Internet appliance connected directly to the high-speed modem automatically, i.e., without user intervention, when the high-speed modem fails. In this second embodiment, the system of the present invention involves four components: (1) a modem monitoring software module resident on the high-speed modem; (2) a modem recovery software module resident on the Internet appliance connected directly to the high-speed modem; (3) an ICS software module resident on the Internet appliance connected directly to the high-speed modem; and (4) a communications protocol.

The modem monitoring software module resident on the high-speed modem monitors the operation of the high-speed modem to detect any high-speed modem failure. If the high-speed modem fails, the modem monitoring software module communicates the failure to the modem recovery software module resident on the Internet appliance using the communications protocol. The modem recovery software module automatically launches a dial-up connection on the Internet appliance and instructs the ICS software module of the dial-up connection without interruption of Internet access. The dial-up modem connection is launched on a dial-up modem that may be a standalone device connected to the Internet appliance or integrated into the Internet appliance. The modem monitoring software module may be the same as the modem monitoring software module used in the first embodiment of the present invention. Similarly, the communications protocol may be the same as the communications protocol used in the first embodiment of the present invention.

The ICS software module is a software module that shares an Internet connection among multiple interconnected Internet appliances. The ICS module shares a single IP address among all the Internet appliances and routes all packets coming from/to the Internet appliances that are not directly connected to the high-speed modem or the dial-up modem to the Internet appliance that is directly connected to the high-speed modem and the dial-up modem.

In yet a third embodiment of the present invention, when the high-speed modem is connected to various Internet appliances on a LAN through a router, the failure recovery is accomplished by using one of the Internet appliances connected to the router as a gateway with a dial-up connection and directing all the other Internet appliances to the gateway. This way, when the high-speed modem fails, Internet access is guaranteed by a single dial-up connection on the gateway that is shared by all the Internet appliances connected to the router. The router is not required to have additional hardware, and simply routes the Internet packets from/to the other Internet appliances to the gateway.

In this third embodiment, the system of the present invention involves four main software components: (1) a modem interchange software module resident on the router; (2) a modem backup software module resident on an Internet appliance connected to the router so that the Internet appliance can act as a gateway; (3) an ICS software module resident on the gateway; and (4) a communications protocol between the router and the gateway.

The modem interchange software module resident on the router handles the switch from the high-speed modem to a dial-up modem that may be a standalone device connected to the gateway or integrated into the gateway. The modem interchange software module detects the high-speed modem failure and communicates the failure to the modem backup software module on the gateway using the communications protocol. The communications protocol between the router and the gateway may be the same as the communications protocol used in the first two embodiments of the present invention for communications between an Internet appliance and a high-speed modem connected directly to the Internet appliance, i.e., without the need of a router.

The modem backup software module launches the ICS software module on the gateway so that all the other Internet appliances connected to the router can maintain their Internet connection. The ICS software module is a software module that shares a single IP address with all the other Internet appliances connected on the LAN through the router. The router then routes all the other Internet appliances to the gateway so that the ICS module on the gateway can provide Internet access capabilities to the Internet appliances through the dial-up modem.

When the high-speed modem service resumes, the modem interchange software module resident on the router communicates the service reactivation to the modem backup software module resident on the gateway using the communications protocol. The modem backup software module instructs the ICS software module to deactivate its shared connection and communicates the deactivation back to the router. The router then proceeds to resume the high-speed modem service to all the Internet appliances connected in the LAN.

In a fourth and preferred embodiment of the present invention, when the high-speed modem is connected to various Internet appliances on a LAN through a router, the failure recovery is accomplished by using one of the Internet appliances connected to the router as a gateway with a dial-up connection and a data redirection software module for redirecting all the data coming in through the dial-up connection to the router, which then routes the data to the appropriate Internet appliance. Data coming out of the Internet appliances destined for the Internet is first sent to the router, which then forwards the data through its LAN port to the data redirection software module in the Internet appliance connected directly to the dial-up modem. The data redirection software module then sends the data out the Internet. This way, the added router capabilities of the ICS software module of the third embodiment are eliminated and a single router is used to route data in the LAN.

In this fourth and preferred embodiment, the system of the present invention involves four main software components: (1) a modem interchange software module resident on the router; (2) a modem backup software module resident on an Internet appliance connected to the router so that the Internet appliance can act as a gateway; (3) a data redirection software module resident on the gateway; and (4) a communications protocol between the router and the gateway.

The modem interchange software module resident on the router handles the switch from the high-speed modem to a dial-up modem that may be a standalone device connected to the gateway or integrated into the gateway. The modem interchange software module detects the high-speed modem failure and communicates the failure to the modem backup software module on the gateway using the communications protocol. The communications protocol between the router and the gateway may be the same as the communications protocol used in the first three embodiments of the present invention.

The modem backup software module launches the dial-up modem connection and the data redirection software module on the gateway so that all the other Internet appliances connected to the router can maintain their Internet connection. The data redirection software module redirects all the data coming in through the dial-up connection to the router, which then routes the data to the appropriate Internet appliance. Data coming out of the Internet appliances destined for the Internet is first sent to the router, which then forwards the data through its LAN port to the data redirection software module in the gateway. The data redirection software module then sends the data out the Internet.

When the high-speed modem service resumes, the modem interchange software module resident on the router communicates the service reactivation to the modem backup software module resident on the gateway using the communications protocol. The modem backup software module deactivates the dial-up connection and communicates the deactivation back to the router. The router then proceeds to resume the high-speed modem service to all the Internet appliances connected in the LAN.

Advantageously, the system and method of the present invention provide users on a LAN with around-the-clock Internet access without requiring additional hardware or significant changes to the LAN router. In addition, the system and method of the present invention enable the router to automatically switch from a high-speed modem to a dial-up modem so that the switch is transparent to all the users on the LAN. The system and method of the present invention also enable a user directly connected to a high-speed modem, i.e., without the need of a router, to have uninterrupted Internet access in case of high-speed modem failure.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic view of the system and the network environment of the first embodiment of the present invention;

FIG. 2 is a schematic view of the software components used in the first embodiment of the present invention illustrated in FIG. 1;

FIG. 3 is a schematic view of the system and network environment of the second embodiment of the present invention;

FIG. 4 is a schematic view of the software components used in the second embodiment of the present invention illustrated in FIG. 3;

FIG. 5 is an illustrative flowchart for activating a backup dial-up modem connection in case of high-speed modem failure when the high-speed modem is connected directly to an Internet appliance;

FIG. 6 is an illustrative flowchart for reactivating a high-speed modem connection when the high-speed modem is connected directly to an Internet appliance;

FIG. 7 is a schematic view of the system and the network environment of the third embodiment of the present invention;

FIG. 8 is a schematic view of the software components used in the third embodiment of the present invention illustrated in FIG. 7;

FIG. 9 is a schematic view of the system and the network environment of the fourth embodiment of the present invention;

FIG. 10 is a schematic view of the software components used in the fourth embodiment of the present invention illustrated in FIG. 9;

FIG. 11 is an illustrative flowchart for activating a backup dial-up modem connection on the gateway in case of high-speed modem failure when the high-speed modem is connected to a LAN through a router;

FIG. 12 is an illustrative flowchart for reactivating a high-speed modem connection when the high-speed modem is connected to a LAN through a router;

FIG. 13 is an illustrative flowchart for activating a backup dial-up modem connection on the gateway in case of high-speed modem failure when the high-speed modem is connected to a LAN through a router; and

FIG. 14 is an illustrative flowchart for reactivating a high-speed modem connection when the high-speed modem is connected to a LAN through a router.

### DETAILED DESCRIPTION OF THE DRAWINGS

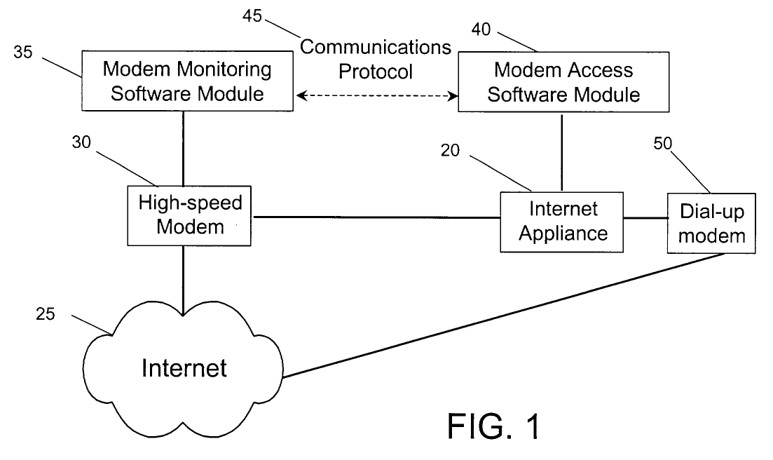

Referring to FIG. 1, a schematic view of the system and the network environment of the first embodiment of the present invention is described. Internet appliance 20 connect to Internet 25 through high-speed modem 30. Internet appliance 20 may be any electronic device configured with an Internet access system, such as a personal computer, a portable computer, an electronic organizer, a PDA, a wireless telephone, an entertainment system, a stereo system, a video game unit, a household appliance, or an embedded electronic device, among others. High-speed modem 30 may be a DSL modem such as the external USB home DSL modem sold by Actiontec Electronics, Inc., of Sunnyvale, Calif., or a cable modem such as the Etherfast cable modem sold by Linksys, of Irvine, Calif. It should be understood by one skilled in the art that high-speed modem 30 may be a standalone device or integrated into Internet appliance 20.

High-speed modem 30 is equipped with modem monitoring software module 35 to monitor the operation of high-speed modem 30 and detect any failure. If high-speed modem 30 fails, modem monitoring software module 35 communicates the failure to modem access software module 40 resident on Internet appliance 20 using communications protocol 45. Modem access software module 40 automatically launches a dial-up connection on Internet appliance 20 without interruption of Internet access. The dial-up connection is launched on dial-up modem 50 that may be a standalone device connected to Internet appliance 20 or integrated into Internet appliance 20.

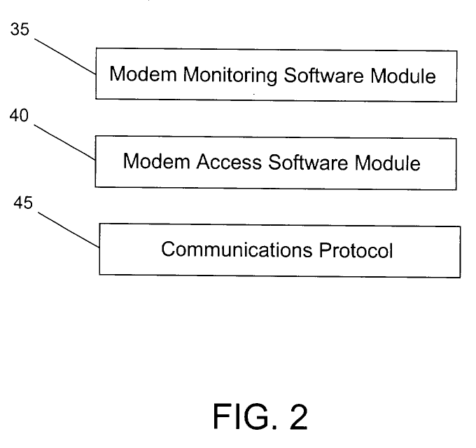

Referring now to FIG. 2, a schematic view of the software components used in the embodiment of the present invention illustrated in FIG. 1 is described. The software components consist of: (1) modem monitoring software module 35; (2) modem access software module 40; and (3) communications protocol 45.

Modem monitoring software module 35 is a software module resident on high-speed modem 30 responsible for monitoring the status of high-speed modem 30 to communicate any failure of high-speed modem 30 to modem access software module 40. Modem access software module 40 is a software module resident on Internet appliance 20 for launching a dial-up connection on dial-up modem 50 when high-speed modem 30 fails. The dial-up connection is launched automatically so that a user of Internet appliance 20 is provided with uninterrupted Internet access.

Communications protocol 45 is a protocol between modem monitoring software module 35 and modem access software module 40 for exchanging messages during the transition from high-speed modem 30 to dial-up modem 50 and vice-versa.

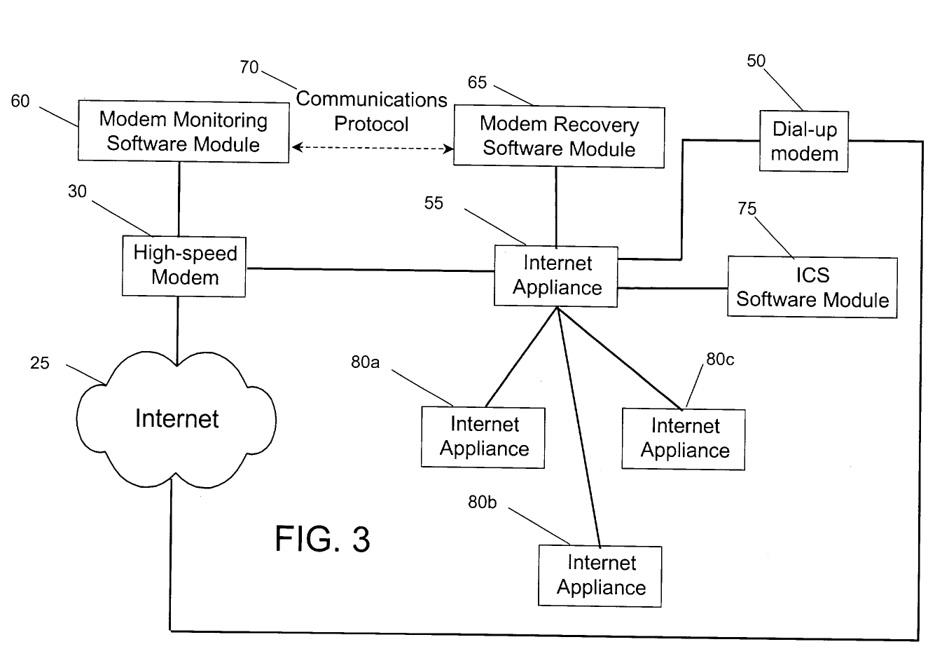

Referring now to FIG. 3, a schematic view of the system and network environment of the second embodiment of the present invention is described. Internet appliance 55 connect to Internet 25 through high-speed modem 30. Internet appliance 55 may be any electronic device configured with an Internet access system, such as a personal computer, a portable computer, an electronic organizer, a PDA, a wireless telephone, an entertainment system, a stereo system, a video game unit, a household appliance, or an embedded electronic device, among others. High-speed modem 30 may be a DSL modem such as the external USB home DSL modem sold by Actiontec Electronics, Inc., of Sunnyvale, Calif., or a cable modem such as the Etherfast cable modem sold by Linksys, of Irvine, Calif. It should be understood by one skilled in the art that high-speed modem 30 may be a standalone device or integrated into Internet appliance 55.

Internet appliance 55 is connected to Internet appliances 80a-c on a LAN topology, such as a ring or bus topology. Internet appliances 80a-c connect to Internet 25 through high-speed modem 30 and ICS software module 75. ICS software module 75 is a software module that shares an Internet connection among multiple interconnected Internet appliances. ICS software module 75 shares a single IP address among Internet appliances 55 and 80a-c and routes all packets coming from/to Internet appliances 80a-c through Internet appliance 55.

High-speed modem 30 is equipped with modem monitoring software module 60 to monitor the operation of high-speed modem 30 and detect any failure. If high-speed modem 30 fails, modem monitoring software module 60 communicates the failure to modem recovery software module 65 resident on Internet appliance 55 using communications protocol 310. Modem recovery software module 65 automatically launches a dial-up connection on Internet appliance 55 and instructs ICS software module 75 of the dial-up connection without interruption of Internet access. The dial-up connection is launched on dial-up modem 50 that may be a standalone device connected to Internet appliance 55 or integrated into Internet appliance 55.

It should be understood by one skilled in the art that communications protocol 70 may be the same as communications protocol 45 used in the first embodiment of the present invention.

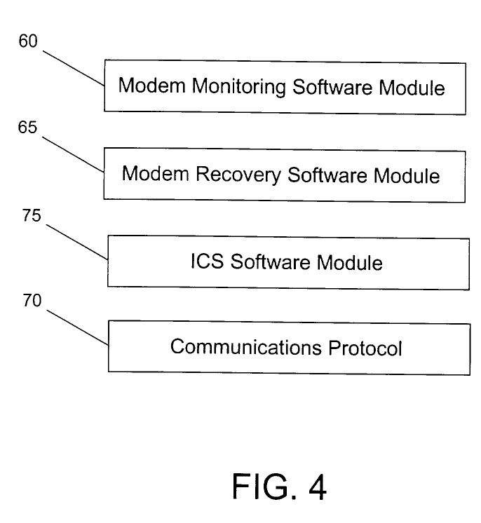

Referring now to FIG. 4, a schematic view of the software components used in the second embodiment of the present invention illustrated in FIG. 3 is described. The software components consist of: (1) modem monitoring software module 60; (2) modem recovery software module 65; (3) ICS software module 75; and (3) communications protocol 70.

Modem monitoring software module 60 is a software module resident on high-speed modem 30 responsible for monitoring the status of high-speed modem 30 to communicate any failure of high-speed modem 30 to modem recovery software module 65. Modem recovery software module 65 is a software module resident on Internet appliance 55 for launching a dial-up connection on dial-up modem 50 and instructing ICS software module 75 of the dial-up connection when high-speed modem 30 fails. The dial-up connection is launched automatically so that a user of Internet appliance 55 is provided with uninterrupted Internet access.

ICS software module 75 is a software module that shares an Internet connection among multiple interconnected Internet appliances. ICS software module 75 shares a single IP address among Internet appliances 55 and 80a-c and routes all packets coming from/to Internet appliances 80a-c through Internet appliance 55. Communications protocol 70 is a protocol between modem monitoring software module 60 and modem recovery software module 65 for exchanging messages during the transition from high-speed modem 30 to dial-up modem 50 and vice-versa.

It should be understood by one skilled in the art that communications protocol 70 may be the same as communications protocol 45 used in the first embodiment of the present invention. It should also be understood by one skilled in the art that modem monitoring software module 60 may be the same as modem monitoring software module 35 used in the first embodiment of the present invention.

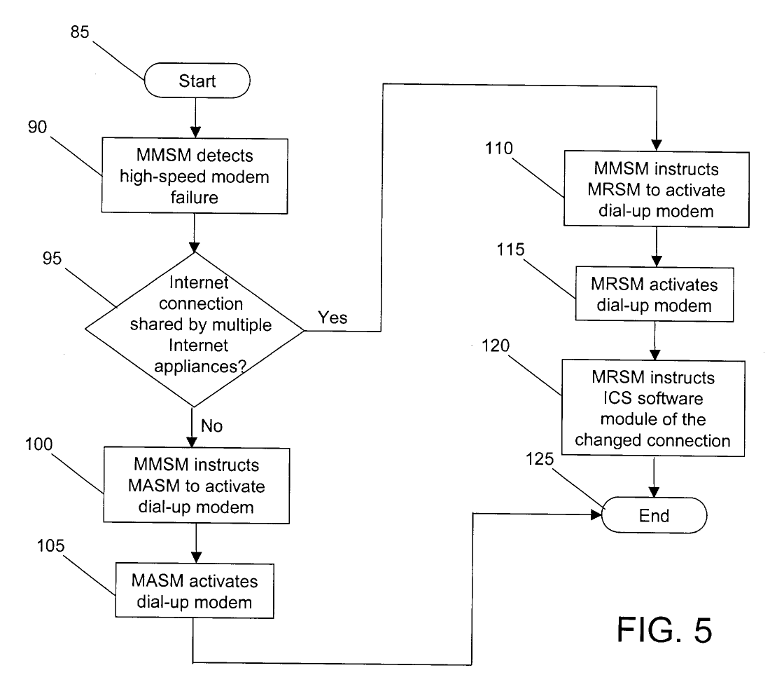

Referring now to FIG. 5, an illustrative flowchart for activating a backup dial-up modem connection in case of high-speed modem failure when the high-speed modem is connected directly to an Internet appliance is described. At step 85, modem monitoring software module (“MMSM”) 35 detects a failure of high-speed modem 30. At step 90, if there is a single Internet appliance connected to high-speed modem 30, MMSM 35 communicates the failure of high-speed modem 30 to modem access software module (“MASM”) 40 using communications protocol 45. At step 100, MASM 40 automatically launches dial-up modem 50 so that a user of Internet appliance 20 is provided with uninterrupted Internet access.

If the high-speed modem connection is shared among multiple Internet appliances, e.g., the Internet connection shared between Internet appliances 55 and 80a-c through high-speed modem 30 as illustrated in FIG. 3, at step 110, MMSM 60 instructs modem recovery software module (“MRSM”) 65 to activate dial-up modem 50. At step 115, MRSM 65 activates dial-up modem 50, and, at step 120, MRSM 65 instructs ICS software module 75 that the Internet connection shared between Internet appliances 55 and 80a-c is a dial-up connection through dial-up modem 50.

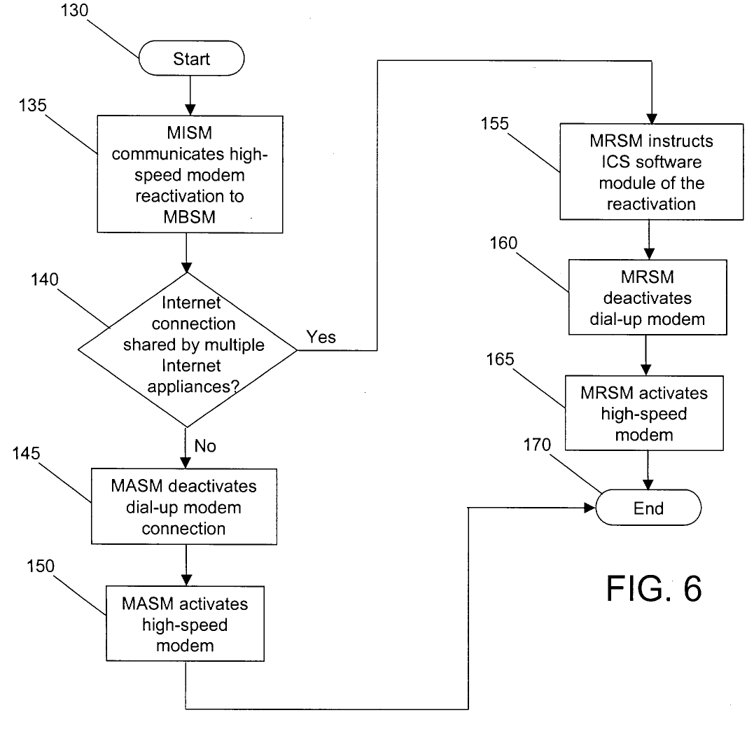

Referring now to FIG. 6, an illustrative flowchart for reactivating a high-speed modem connection when the high-speed modem is connected directly to an Internet appliance is described. At step 135, MMSM 35 detects that high-speed modem 30 has been reactivated and communicates the reactivation to MASM 40 in Internet appliance 20 using communications protocol 45. If the high-speed modem connection is not shared among multiple Internet appliances (140), MASM 40 in Internet appliance 20 deactivates the dial-up modem connection through dial-up modem 50 at step 145. MASM 40 then activates the high-speed modem connection for Internet appliance 20 at step 150 so that all packets from/to Internet appliance 20 to/from Internet 25 are sent via high-speed modem 30.

If the high-speed modem connection is shared among multiple Internet appliances, e.g., the Internet connection shared between Internet appliances 55 and 80a-c through high-speed modem 30 as illustrated in FIG. 3, at step 155, MRSM 65 instructs ICS software module 75 of the reactivation of high-speed modem 30. Then, at step 160, MRSM 65 deactivates the dial-up modem connection and, at step 165 activates the high-speed modem connection.

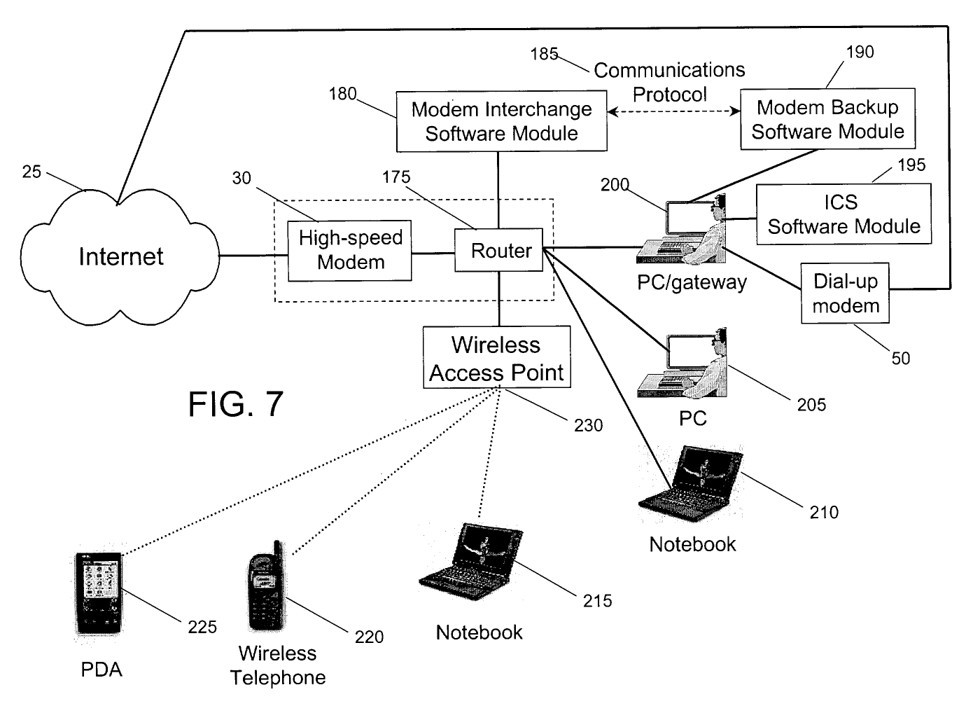

Referring now to FIG. 7, a schematic view of the system and the network environment of the third embodiment of the present invention is described. In this third embodiment, Internet appliances 200-225 connect to Internet 25 through router 175 via high-speed modem 30. Internet appliances 200-210 connect to router 175 through a wired connection, while Internet appliances 215-225 connect to router 175 by means of a wireless connection through wireless access point 230. High-speed modem 30 may be a DSL modem such as the external USB home DSL modem sold by Actiontec Electronics, Inc., of Sunnyvale, Calif., or a cable modem such as the Etherfast cable modem sold by Linksys, of Irvine, Calif. It should be understood by one skilled in the art that router 175 may be a standalone device or integrated into high-speed modem 30.

Router 175 is equipped with modem interchange software module 180 to provide uninterrupted Internet access to Internet appliances 200-225. When high-speed modem 30 fails, modem interchange software module 180 detects that failure and activates dial-up modem 50 connected to Internet appliance 200. Internet appliances 200-225 then continue accessing Internet 25 without an interruption through router 175 and Internet appliance 200.

It should be understood by one skilled in the art that dial-up modem 50 can be a standalone dial-up modem external to Internet appliance 200 as shown in FIG. 7 or integrated into Internet appliance 200.

The dial-up modem connection is activated by modem backup software module 190 on Internet appliance 200. Modem backup software module 190 initiates a dial-up modem connection on Internet appliance 200 and launches ICS software module 195, so that Internet appliances 205-225 can share a single IP address with Internet appliance 200, which therefore functions as a gateway. When ICS software module 195 is activated, modem backup software module 190 communicates the activation to modem interchange software module 180 using communications protocol 185. Router 175 then routes all the packets from/to Internet appliances 205-225 to/from Internet 25 through gateway 200.

When high-speed modem 30 resumes normal operation, modem interchange software module 180 detects that change and communicates that status to modem backup software module 190. Modem backup software module 190 then instructs ICS software module 195 to deactivate its shared connection with Internet appliances 205-225 and notifies router 175 when the dial-up connection has been shut down. Router 175 then proceeds to resume the high-speed modem service to all of Internet appliances 200-225.

It should be understood by one skilled in the art that any or all of Internet appliances 200-225 may be equipped with ICS software module 195. In this case, router 175 may designate a default Internet appliance to act as a gateway, or it may instruct modem interchange software module 180 to decide which one of Internet appliances 200-225 will be selected to act as a gateway.

It should also be understood by one skilled in the art that communications protocol 185 between modem interchange software module 180 and modem backup software module 190 may be the same as communications protocol 45 used in the first embodiment of the present invention for communications between modem monitoring software module 35 and modem access software module 40.

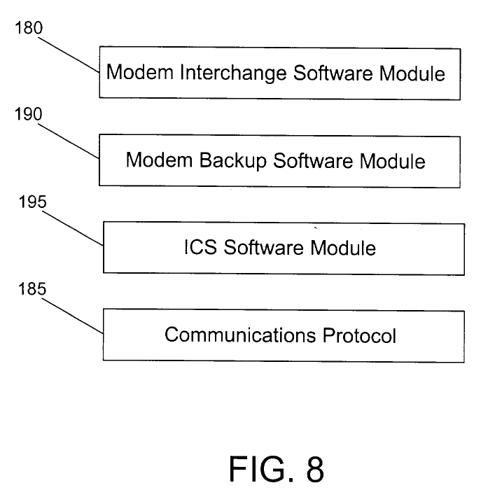

Referring now to FIG. 8, a schematic view of the software components used in the third embodiment of the present invention illustrated in FIG. 7 is described. The software components consist of: (1) modem interchange software module 180; (2) modem backup software module 190; (3) ICS software module 195; and (4) communications protocol 185.

Modem interchange software module 180 is a software module resident on router 175 responsible for handling the switch from high-speed modem 30 to dial-up modem 50 connected to gateway 200 when high-speed modem 30 fails. Modem interchange software module 180 detects the failure of high-speed modem 30 and communicates the failure to modem backup software module 190 on gateway 200 using communications protocol 180. Additionally, modem interchange software module 180 instructs router 175 to route packets from/to Internet appliances 205-225 to/from Internet 25 through gateway 200 when dial-up modem 50 is activated and to resume the high-speed connection to Internet 25 through high-speed modem 30 when high-speed modem 30 resumes normal operation. When this happens, modem interchange software module 180 also instructs modem backup software module 190 to deactivate ICS software module 195.

Modem backup software module 190 activates dial-up modem 50 connected to gateway 200 and launches ICS software module so that Internet appliances 205-225 connected to router 175 can maintain their connection to Internet 25. Modem backup software module 190 also communicates the activation of ICS software module 195 to modem interchange software module 180 using communications protocol 180. Further, modem backup software module 190 instructs gateway 200 to stop running ICS software module 195 upon receiving notice from modem interchange software module 180 that high-speed modem 30 has resumed normal operation.

ICS software module 195 is a software module that shares a single IP address with all the other Internet appliances connected in the LAN through the router. When high-speed modem 30 fails, ICS software module 195 is launched by modem backup software module 190 to share gateway 200's connection to Internet 25 with Internet appliances 205-225. ICS software module 195 assigns IP addresses to Internet appliances 205-225 and maps the IP addresses into the single IP address assigned to gateway 200 by router 175.

Communications protocol 180 is a protocol between modem interchange software 180 and modem backup software module 190 for exchanging messages during the transition from high-speed modem 30 to dial-up modem 50 and vice-versa.

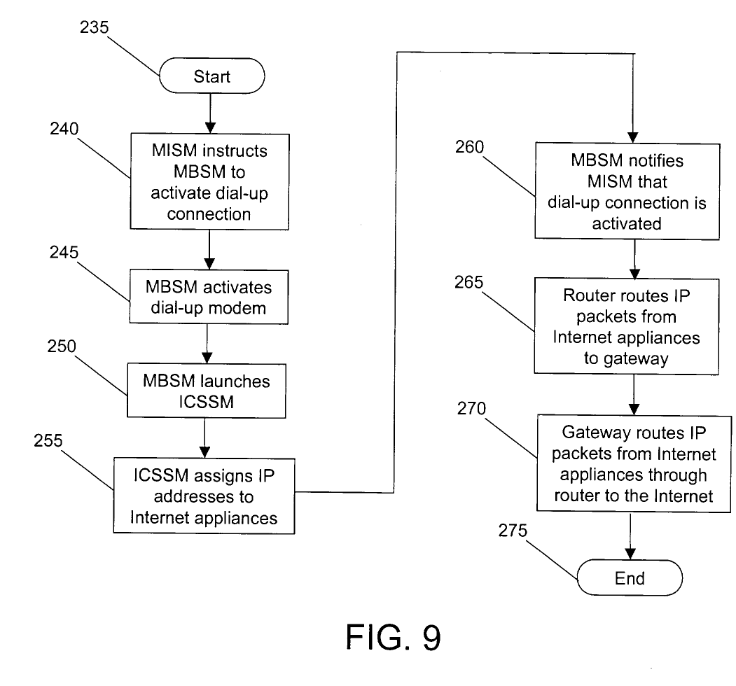

Referring now to FIG. 9, an illustrative flowchart for activating a backup dial-up modem connection on the gateway in case of high-speed modem failure when the high-speed modem is connected to a LAN through a router is described. At step 235, modem interchange software module (“MISM”) 180 instructs modem backup software module (“MBSM”) 190 to activate the dial-up connection on gateway 200. At step 240, MBSM 190 activates dial-up modem 50 connected to gateway 200. Dial-up modem 50 may be a standalone device external to gateway 200 as shown in FIG. 7, or integrated into gateway 200.

At step 250, MBSM 190 launches ICS software module (“ICSSM”) 195 on gateway 200. At step 255, ICSSM 195 assigns IP addresses to Internet appliances 205-225 so that Internet appliances 205-225 can share the single IP address assigned to gateway 200 by router 175 to access Internet 25 with a slower dial-up connection when high-speed modem 30 fails. After ICSSM 195 is launched, MBSM 190 notifies MISM 180 at step 260 that the dial-up connection to dial-up modem 50 is activated.

At step 265, router 175 routes any IP packets from/to Internet appliances 205-225 to/from Internet 25 through gateway 200 and at step 270, gateway 200 routes any IP packets from Internet appliances 205-225 to Internet 25 through router 175.

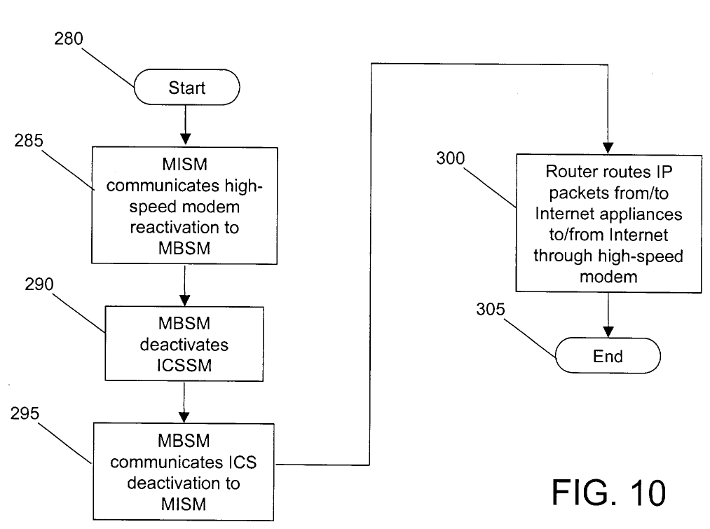

Referring now to FIG. 10, an illustrative flowchart for reactivating a high-speed modem connection when the high-speed modem is connected to a LAN through a router is described. At step 285, MISM 180 communicates the high-speed service reactivation to MBSM 190 using communications protocol 185. MBSM 190 then instructs ICSSM 195 at step 290 to deactivate its shared dial-up connection to dial-up modem 50 and communicates the deactivation back to MISM 180 at step 295.

At step 300, router 175 proceeds to resume the high-speed modem service to all of Internet appliances 200-225 by routing IP packets from/to Internet appliances 200-225 to/from Internet 25 through high-speed modem 30.

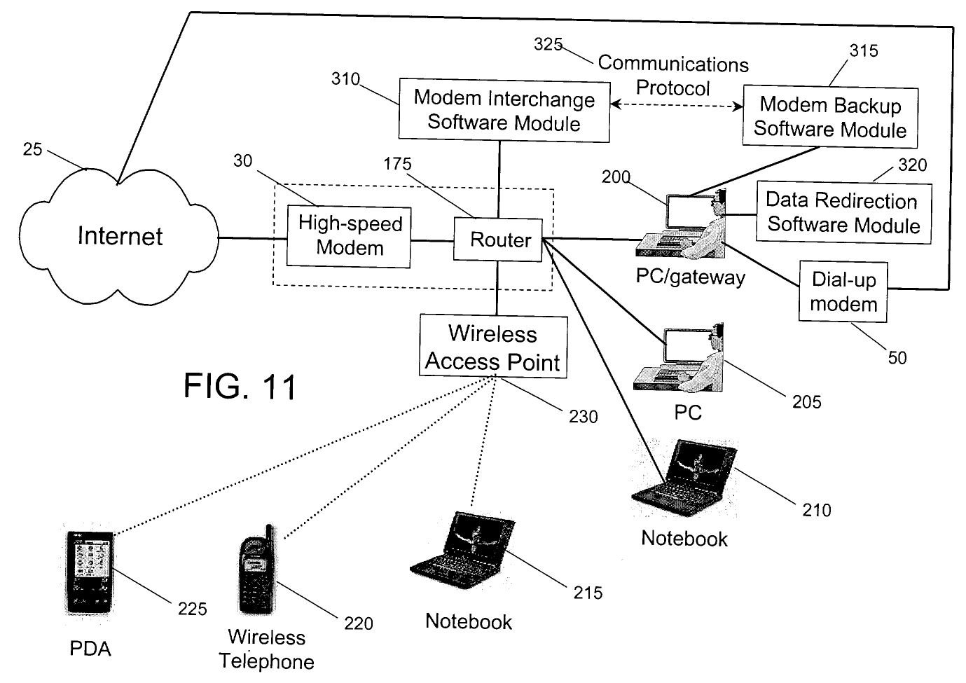

Referring now to FIG. 11, a schematic view of the system and the network environment used in the fourth embodiment of the present invention is described. In this fourth embodiment, Internet appliances 200-225 connect to Internet 25 through router 175 via high-speed modem 30. Internet appliances 200-210 connect to router 175 through a wired connection, while Internet appliances 215-225 connect to router 175 by means of a wireless connection through wireless access point 230. High-speed modem 30 may be a DSL modem such as the external USB home DSL modem sold by Actiontec Electronics, Inc., of Sunnyvale, Calif., or a cable modem such as the Etherfast cable modem sold by Linksys, of Irvine, Calif. It should be understood by one skilled in the art that router 175 may be a standalone device or integrated into high-speed modem 30.

Router 175 is equipped with modem interchange software module 310 to provide uninterrupted Internet access to Internet appliances 200-225. When high-speed modem 30 fails, modem interchange software module 310 detects that failure and activates dial-up modem 50 connected to Internet appliance 200. Internet appliances 200-225 then continue accessing Internet 25 without an interruption through router 175 and Internet appliance 200.

It should be understood by one skilled in the art that dial-up modem 30 can be a standalone dial-up modem external to Internet appliance 200 as shown in FIG. 11 or integrated into Internet appliance 200.

The dial-up modem connection is activated by modem backup software module 315 on Internet appliance 200. Modem backup software module 315 initiates a dial-up modem connection on Internet appliance 200 and launches data redirection software module 320 for redirecting all the data coming in through the dial-up connection to router 175, which then routes the data to the appropriate Internet appliance, which may be any of Internet appliances 200-225. Data coming out of Internet appliances 200-225 destined for Internet 25 is first sent to router 175, which then forwards the data through its LAN port to data redirection software module 320 in Internet appliance 200. Data redirection software module 320 then sends the data to Internet 25. This way, the added router capabilities of ICS software module 195 of the third embodiment shown in FIG. 7 are eliminated and a single router, i.e., router 175 is used to route data in the LAN.

When high-speed modem 30 resumes normal operation, modem interchange software module 310 detects that change and communicates that status to modem backup software module 315. Modem backup software module 315 then instructs data redirection software module 320 to interrupt its data redirection and notifies router 175 when the dial-up connection has been shut down. Router 175 then proceeds to resume the high-speed modem service to all of Internet appliances 200-225.

It should also be understood by one skilled in the art that communications protocol 325 between modem interchange software module 310 and modem backup software module 315 may be the same as communications protocol 45 used in the first embodiment of the present invention for communications between modem monitoring software module 35 and modem access software module 40.

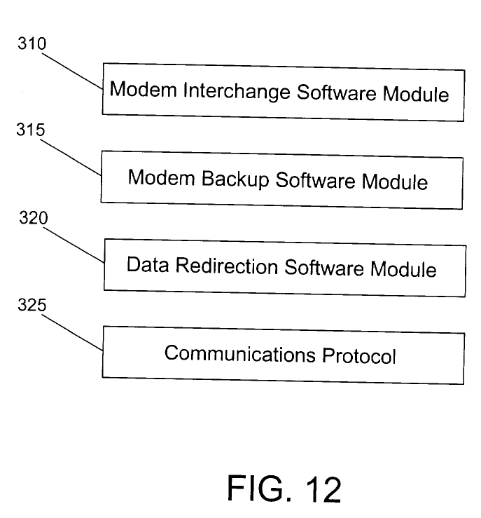

Referring now to FIG. 12, a schematic view of the software components used in the fourth embodiment of the present invention illustrated in FIG. 11 is described. The software components consist of: (1) modem interchange software module 310 resident on router 175; (2) modem backup software module 315 resident on Internet appliance 200 connected to router 175 so that Internet appliance 200 can act as a gateway; (3) data redirection software module 320 resident on the gateway; and (4) communications protocol 325 between the router and the gateway.

Modem interchange software module 310 resident on router 175 handles the switch from high-speed modem 30 to dial-up modem 50 that may be a standalone device connected to the gateway or integrated into the gateway. Modem interchange software module 310 detects the high-speed modem failure and communicates the failure to modem backup software module 315 on the gateway using communications protocol 325. Communications protocol 325 between the router and the gateway may be the same as the communications protocols used in the first three embodiments of the present invention.

Modem backup software module 315 launches the dial-up modem connection and data redirection software module 320 on the gateway so that Internet appliances 205-225 connected to router 175 can maintain their Internet connection. Data redirection software module 320 redirects all the data coming in through the dial-up connection to router 175, which then routes the data to the appropriate Internet appliance. Data coming out of Internet appliances 200-225 destined for Internet 25 is first sent to router 175, which then forwards the data through its LAN port to data redirection software module 320 in the gateway. Data redirection software module 320 then sends the data to Internet 25.

When the high-speed modem service resumes, modem interchange software module 310 resident on router 175 communicates the service reactivation to modem backup software module 315 resident on the gateway using communications protocol 325. Modem backup software module 315 deactivates the dial-up connection and communicates the deactivation back to router 175. Router 175 then proceeds to resume the high-speed modem service to Internet appliances 200-225 connected in the LAN.

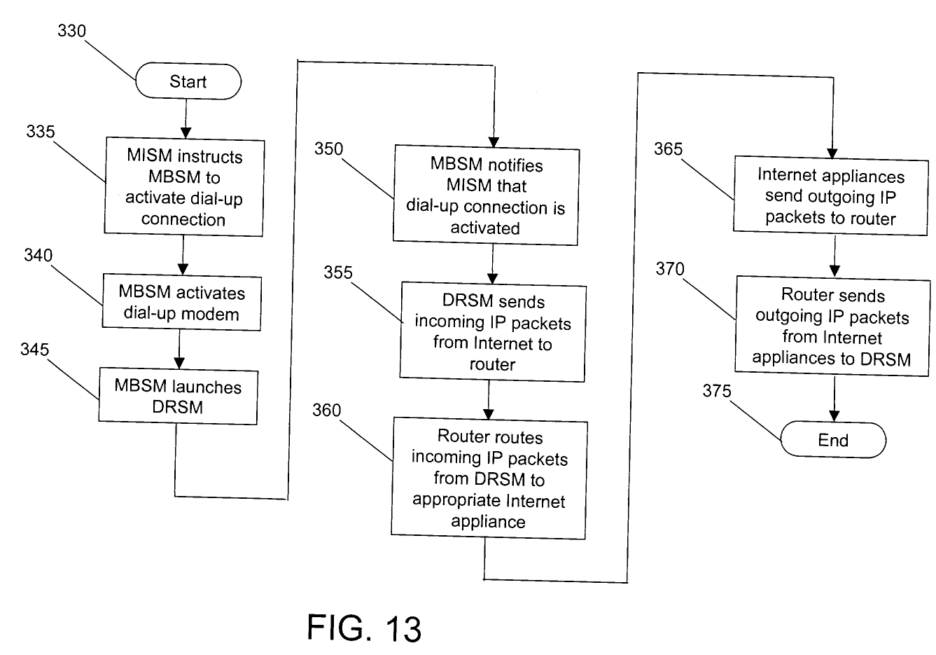

Referring now to FIG. 13, an illustrative flowchart for activating a backup dial-up modem connection on the gateway in case of high-speed modem failure when the high-speed modem is connected to a LAN through a router is described. At step 335, modem interchange software module (“MISM”) 310 instructs modem backup software module (“MBSM”) 315 to activate the dial-up connection on gateway 200. At step 340, MBSM 315 activates dial-up modem 50 connected to gateway 200. Dial-up modem 50 may be a standalone device external to gateway 200 as shown in FIG. 1, or integrated into gateway 200.

At step 345 MBSM 85 launches data redirection software module (“DRSM”) 320 on gateway 200. At step 350, MBSM 315 notifies MISM 310 that the dial-up connection is activated. At step 355, DRSM 320 sends all incoming IP packets coming from Internet 25 through dial-up modem 50 on gateway 200 to router 175. At step 360, router 175 routes the incoming IP packets to the appropriate Internet appliance, i.e., the Internet appliances for which the incoming IP packets are destined. At step 365, Internet appliances 200-225 send any outgoing IP packets to router 175. Then, at step 370, router 175 sends the outgoing IP packets to DRSM 320 on gateway 200 so that DRSM 320 may forward the packets to Internet 25.

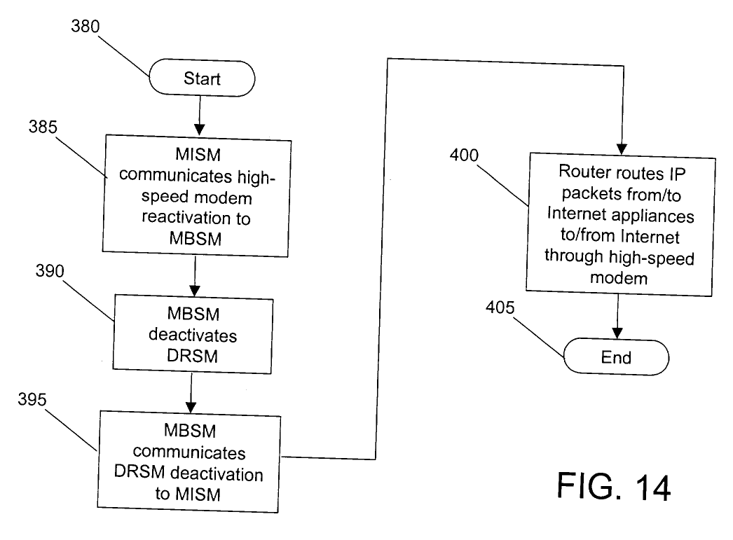

Referring now to FIG. 14, an illustrative flowchart for reactivating a high-speed modem connection when the high-speed modem is connected to a LAN through a router is described. At step 385, MISM 310 communicates the high-speed service reactivation to MBSM 315 using communications protocol 325. MBSM 315 then communicates the deactivation back to MISM 310 at step 395.

Lastly, at step 400, router 175 proceeds to resume the high-speed modem service to all of Internet appliances 200-225 by routing IP packets from/to Internet appliances 200-225 to/from Internet 25 through high-speed modem 30.

Although particular embodiments of the present invention have been described above in detail, it will be understood that this description is merely for purposes of illustration. Specific features of the invention are shown in some drawings and not in others, and this is for convenience only and any feature may be combined with another in accordance with the invention. Steps of the described processes may be reordered or combined, and other steps may be included. Further variations will be apparent to one skilled in the art in light of this disclosure and are intended to fall within the scope of the appended claims.

What is claimed is:

1. A method for providing uninterrupted Internet access to a user of an Internet appliance, the method comprising:
providing high-speed Internet access through a high-speed modem connected to the Internet appliance;
monitoring a status of the high-speed modem; and
launching a dial-up Internet connection application on the Internet appliance without user intervention when failure of the high-speed modem is detected.

2. The method of claim 1, wherein providing high-speed Internet access through a high-speed modem connected to the Internet appliance comprises providing a high-speed modem connected to the Internet appliance directly and without a router.

3. The method of claim 1, wherein providing high-speed Internet access through a high-speed modem connected to the Internet appliance comprises connecting the high-speed modem to the Internet appliance through a router to a local area network comprising the Internet appliance.

4. The method of claim 1, wherein the Internet appliance comprises one or more of: a personal computer; a portable computer; a wireless telephone; a personal digital assistant; an entertainment system; a stereo system; a video game unit; a household appliance; and an embedded electronic device.

5. The method of claim 1, wherein the Internet appliance comprises a dial-up modem.

6. The method of claim 1, wherein the Internet appliance comprises a gateway to the local area network.

7. The method of claim 1, wherein launching a dial-up Internet connection application comprises activating the dial-up modem in the Internet appliance without user intervention when failure of the high-speed modem is detected.

8. The method of claim 1, wherein launching a dial-up Internet connection application comprises routing packets from the local area network to the Internet through the Internet appliance via the router when failure of the high-speed modem is detected.

9. The method of claim 1, wherein launching a dial-up Internet connection application comprises forwarding packets from the Internet to the local area network through the Internet appliance and routing the packets from the Internet appliance through the router to the local area network.

10. The method of claim 1, further comprising resuming high-speed Internet access when the high-speed modem is reactivated.

11. The method of claim 1, further comprising launching an Internet connection sharing routine in the Internet appliance for sharing the high-speed modem and the dial-up modem with a plurality of other Internet appliances connected directly to the Internet appliance.

12. The method of claim 1, further comprising launching an Internet connection sharing routine in the Internet appliance for sharing the dial-up modem with a plurality of other Internet appliances connected to the Internet appliance through a router.

13. A system for providing uninterrupted Internet access to users connected in a local area network, the system comprising:
a plurality of Internet appliances connected to the Internet through a router;
a high-speed modem connected to the router;
a dial-up modem connected to a gateway in the local area network, wherein the gateway comprises an Internet connection sharing routine;
a software routine in the router that monitors the status of the high-speed modem; and
a software routine in the gateway, responsive to the software routine in the router, that activates the dial-up modem and the Internet connection sharing routine when failure of the high-speed modem is detected.

14. The system of claim 13, wherein the gateway comprises one of the plurality of Internet appliances.

15. The system of claim 13, wherein the Internet appliances comprise at least one of: a personal computer; a notebook computer; a wireless telephone; a personal digital assistant; and an entertainment system.

16. The system of claim 13, wherein the software routine in the router comprises:
a routine for instructing the router to route packets through the gateway when failure of the high-speed modem is detected;
a routine for instructing the gateway to cease running the Internet connection sharing routine when the high-speed modem is reactivated; and
a routine for instructing the router to route packets through the high-speed modem when the high-speed modem is reactivated.

17. The system of claim 13, wherein the software routine in the gateway comprises:
a routine for activating the dial-up modem;
a routine for launching the Internet connection sharing routine;
a routine for communicating the dial-up modem activation to the router; and
a routine for instructing the gateway to cease running the Internet connection sharing routine when the high-speed modem is reactivated.

18. The system of claim 13, further comprising a communications protocol for communicating between the router and the gateway.

19. The system of claim 13, wherein the Internet connection sharing routine comprises a data redirection software routine.

20. A system for automatically switching between high-speed Internet access and dial-up Internet access in a local area network, the system comprising:
a plurality of Internet appliances in the local area network;
a gateway comprising an Internet connection sharing routine; and
a router comprising a routine for activating the Internet connection sharing routine when the high-speed Internet access fails.

21. The system of claim 20, further comprising a high-speed modem connected to the router.

22. The system of claim 20, further comprising a dial-up modem.

23. The system of claim 20, wherein the gateway comprises a dial-up modem.

24. The system of claim 20, wherein the router comprises a high-speed modem.

25. The system of claim 20, wherein the Internet connection sharing routine comprises a data redirection routine.

26. The system of claim 20, wherein the routine for activating the Internet connection sharing routine comprises:
a routine for detecting failure in the high-speed modem;
a routine for communicating the failure to the gateway;
a routine for instructing the gateway to launch the Internet connection sharing routine;
a routine for instructing the router to route packets through the gateway when the high-speed modem fails;
a routine for instructing the gateway to stop running the Internet connection sharing routine when the high-speed modem is reactivated; and
a routine for instructing the router to route packets through the high-speed modem when the high-speed modem is reactivated.

27. A high-speed modem, comprising a routine for communicating failure of the high-speed modem to an Internet appliance connected to the high-speed modem and instructing the Internet appliance to launch a dial-up modem connection without user intervention.

28. The high-speed modem of claim 27, wherein the high-speed modem is connected to the Internet appliance directly without a router.

29. The high-speed modem of claim 27, wherein the high-speed modem is connected to the Internet appliance through a router to a local area network comprising the Internet appliance.

30. The high-speed modem of claim 27, wherein the routine comprises a routine for interrupting the dial-up connection when the high-speed modem is reactivated.
